(19) United States
(12) Patent Application Publication
(10) Pub. No.: US 2017/0235605 A1
(43) Pub. Date: Aug. 17, 2017

(54) SYSTEM AND METHOD FOR IMPLEMENTING CLOUD BASED ASYNCHRONOUS PROCESSORS

(71) Applicant: NetSuite Inc., San Mateo, CA (US)

(72) Inventors: Jakub Chaloupka, Brno (CZ); Wei (Michelle) Xue, Redwood City, CA (US); Ivan Omar Parra, Mountain View, CA (US)

(21) Appl. No.: 14/704,724

(22) Filed: May 5, 2015

Related U.S. Application Data
(60) Provisional application No. 61/989,425, filed on May 6, 2014.

(51) Int. Cl. G06F 9/50; G06F 9/48

(52) U.S. Cl. CPC G06F 9/5011; G06F 9/4881; G06F 9/4818

(57) ABSTRACT

Systems, apparatuses, and methods for scheduling the processing of job requests on a data processing platform that utilizes multiple processing elements. In one embodiment, each job request includes a set of attributes that are used to determine scheduling and handling. Such attributes may include job type, priority, priority time, dependency list, and fail on dependency failure flag. In one embodiment, job requests are started in an order determined by the job request attributes of priority and priority time. If a job request has an unresolved dependency, the job request may be removed from the ordered list. Thus, a lower-priority job request may overtake a higher priority job if the higher-priority job has unfinished dependent job requests. Rules for interacting with job requests having these attributes may be customized according to user needs and desires.

### PRIORITY CLAIM

This application claims the benefit of U.S. Provisional Application No. 61/989,425, entitled “System and Method for Implementing Cloud Based Asynchronous Processors,” filed May 6, 2014, which is incorporated by reference in its entirety herein for all purposes.

### BACKGROUND

A data processing platform (such as a multi-tenant platform that is implemented as a web-based or cloud-based service) may be used to process requests from multiple sources (e.g., tenants) for data and the processing of data by business applications (e.g., Enterprise Resource Planning (ERP), Customer-Relationship Management (CRM), eCommerce, and the like). Servicing these requests requires use of data processing and computing resources (e.g., processing cycles, data storage capacity, and the like), which, although substantial, do have certain limitations. For example, data-processing jobs that require a substantial amount of resources (processor time, actual time, memory use) are hampered in terms of being able to be executed synchronously (e.g., as a part of processing of an internet protocol request). This is because the quality of service suffers as users would wait for the completion of these resource-intensive requests (also, a server could be overloaded if it was to serve many of these requests). Therefore, resource-intensive jobs are usually run asynchronously on dedicated machines. In addition, typically some type of queuing system is employed that ensures that only a certain number of jobs can run in parallel.

In such systems, a queueing/scheduling system is often designed to be robust enough to handle all requests such that the system utilitilizes the power of its dedicated machines to the maximum. The queueing/scheduling system typically ensures that jobs of all users are processed as soon as possible according to request priority in an effort to prevent job starvation (i.e., a specific request is perpetually pushed lower by ever-incoming higher priority requests). Further, request dependencies between jobs may further impact the ability of a system to efficiently handle all requests. Further yet, some job requests may not allow for preemption. Therefore, if all request-handling modules of the system run at full capacity and a high-priority job is requested, it is not possible to interrupt a lower-priority job and begin executing the high-priority job. In this situation the high-priority job must wait for a free module. Conventional approaches to the scheduling and execution of requests for data processing and computing resources have limitations and disadvantages in terms of the handling of job priorities and job (inter)dependencies.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 is a diagram illustrating elements or components of an example operating environment in which an embodiment of the subject matter disclosed herein may be implemented;

FIG. 2 is a diagram illustrating additional details of the elements or components of the multi-tenant distributed computing service platform of FIG. 1, in which an embodiment of the subject matter disclosed herein may be implemented;

FIG. 3 is a diagram illustrating a simplified system of FIG. 1, including an integrated business system and an enterprise network in which an embodiment of the subject matter disclosed herein may be implemented;

FIG. 4 in a block diagram of a multi-tenant platform having various component blocks of various computing entities involved with robustly and efficiently handling job requests from multiple tenants according to an embodiment of the subject matter disclosed herein.

FIG. 5 is a flow chart or flow diagram illustrating a process, method, operation, or function for scheduling the processing of a set of job requests using a set of data processing elements, and that may be used when implementing an embodiment of the subject matter disclosed herein; and

FIGS. 6A-6F illustrate an example embodiment of a job work flow as influenced by user customization for asynchronous processing in an exemplary multi-tenant platform suited to execute aspects of the systems and methods described herein.

FIG. 7 is a diagram illustrating elements or components that may be present in a computer device or system configured to implement a method, process, function, or operation in accordance with an embodiment of the subject matter disclosed herein.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. This systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

Among other things, the present subject matter may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that are part of a client device, server, network element, or other form of computing or data processing device/platform and that is programmed with a set of executable instructions (e.g., software instructions), where the instructions may be stored in a suitable non-transitory data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

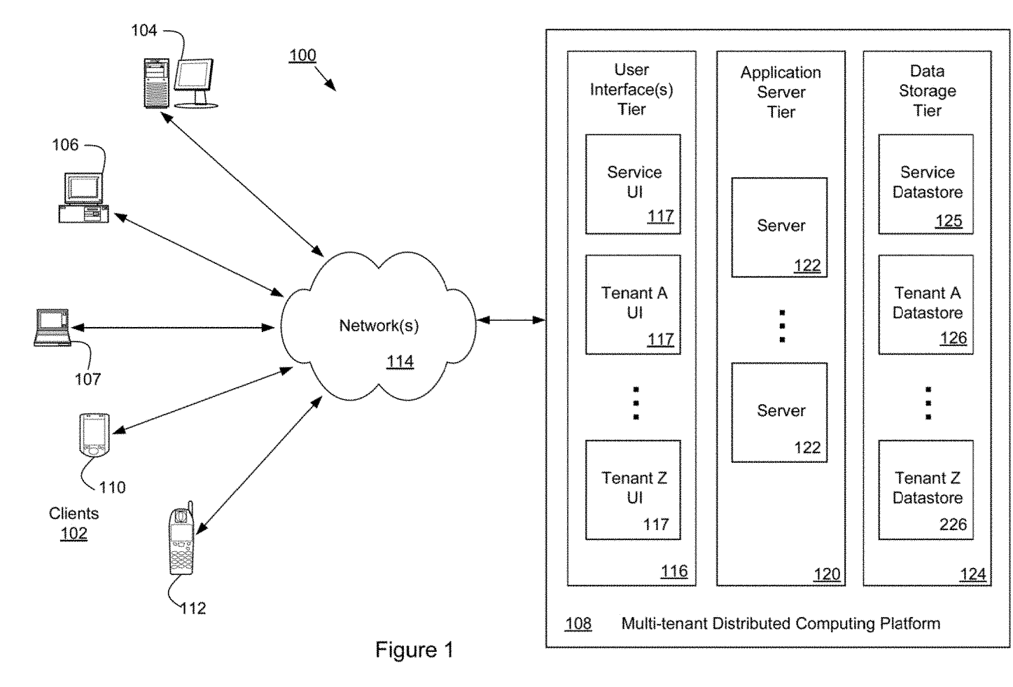

In some embodiments, the subject matter may be implemented in the context of a multi-tenant, “cloud” based environment (such as a multi-tenant business data processing platform), typically used to develop and provide web services and business applications for end users. This exemplary implementation environment will be described with reference to FIGS. 1-3 below. Note that embodiments may also be implemented in the context of other computing or operational environments or systems, such as for an individual business data processing system, a private network used with a plurality of client terminals, a remote or on-site data processing system, another form of client-server architecture, etc.

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions. With differing levels of overlap with ERP/CRM initiatives and with each other, efforts have also been directed toward development of increasingly integrated partner and vendor management systems, as well as web store/eCommerce, product lifecycle management (PLM), and supply chain management (SCM) functionality.

As discussed in the background, in order to ensure a consistent quality of service for the tenants, a multi-tenant, distributed, computing platform (hereinafter, platform) may need to restrict the ability of one operation to consume excessive resources to the detriment of other operations that are executing at the same time (where the resources in question are primarily processing (CPU) time and memory (RAM)). One possible approach to this problem is to begin a timer upon when a data processing operation begins and to SIMPLY terminate the operation if and when the timer expires. While this would prevent excessive use of resources, the approach has multiple drawbacks: it does not restrict access to RAM; it penalizes operations (e.g., scripts) that spend time waiting for an external result to be returned (during which time they are not utilizing any CPU time); and terminating the operation of a single operation in a multi-threaded application requires the system to be built with termination in mind (which is difficult for the platform and not enforceable for any customized operations that may run on top of the platform if the platform is flexible).

Another possible approach is to run a separate instance of the platform for each tenant/customer, wherein each instance includes process-wide resource limits set to prevent interference with other instances that may be executing using the same computing resources. This makes each instance substantially equivalent to a single-tenant platform, thereby negating many of the benefits of multi-tenant platforms, including reduced hardware and management overhead. These solutions have drawbacks as are evident in the discussion below with regard to embodiments of the subject disclosed next and in particular with regard to tenants/customer who may wish to customize operations to meet specific needs.

By way of overview, the subject matter disclosed herein may be systems, apparatuses, and methods for scheduling the processing of tasks (often called jobs or job requests) on a data processing platform that utilizes multiple processing elements. In one embodiment, each job request includes a set of attributes that are used to determine scheduling and handling. Such attributes may include job type, priority, priority time, dependency list, and fail on dependency failure flag. In one embodiment, job requests are started in an order determined by the job request attributes of priority and priority time. If a job request has an unresolved dependency, the job request may be removed from the ordered list. Thus, a lower-priority job request may overtake a higher priority job if the higher-priority job has unfinished dependent job requests.

In one embodiment, a user of the platform may further customize the handling of job requests by specifying a custom job request type. A custom job type may invoke processing by one or more assigned data processors (and other resources) and may utilize one or more assigned memory resources. If no processors are free to be assigned to the custom job request, then the job request may be processed using one or more processors in a common pool of processors for a default category (script, web service, csv, and the like). However, a user may boost the performance of a particular aspect of the system by purchasing access to more processors or assigning more processors to a specific job type (custom or otherwise).

Further yet, a custom job request type may be configured to be handled in several ways via customization. A first way to handle custom job requests is to use user-assigned processors first before using the common pool (but the job request may utilize common pool if available). A second way of handling custom job requests is to use the common pool first, before using any user-assigned processors in order to reserve as much processing resources for the user. Third, a user may customize the handling to use the user-assigned specified processors only and never use or affect the throughput of the common pool of processing resources.

FIG. 1 is a diagram illustrating elements or components of an example operating environment in which an embodiment may be implemented. In FIG. 1, an example operating environment 100 includes a variety of clients 102 incorporating and/or incorporated into a variety of computing devices that may communicate with a distributed computing service/platform 108 through one or more networks 114. For example, a client may incorporate and/or be incorporated into a client application (e.g., software) implemented at least in part by one or more of the computing devices. Examples of suitable computing devices include personal computers, server computers 104, desktop computers 106, laptop computers 107, notebook computers, tablet computers or personal digital assistants (PDAs) 110, smart phones 112, cell phones, and consumer electronic devices incorporating one or more computing device components, such as one or more electronic processors, microprocessors, central processing units (CPU), or controllers. Examples of suitable networks 114 include networks utilizing wired and/or wireless communication technologies and networks operating in accordance with any suitable networking and/or communication protocol (e.g., the Internet).

The distributed computing service/platform (which may also be referred to as a multi-tenant business-data-processing platform) 108 may include multiple processing tiers, including a user interface tier 116, an application server tier 120, and a data storage tier 124. The user interface tier 116 may maintain multiple user interfaces 117, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, and the like. Each processing tier shown in FIG. 1 may be implemented with a set of computers and/or computer components including computer servers and processors, and may perform various functions, methods, processes, or operations as determined by the execution of a software application or set of instructions. The data storage tier 124 may include one or more data stores, which may include a service data store 125 and one or more tenant data stores 126.

Each tenant data store 126 may contain tenant-specific data that is used as part of providing a range of tenant-specific business services or functions, including but not limited to ERP, CRM, eCommerce, Human Resources management, payroll, and the like. Data stores may be implemented with any suitable data storage technology, including structured query language (SQL) based relational database management systems (RDBMS).

In accordance with one embodiment, the distributed computing service/platform 208 may be a multi-tenant and service platform 108 and may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an ERP system that integrates the capabilities of several historically separate business computing systems into a common system, with the intention of streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions. Such functions or business applications are typically implemented by one or more modules of software code/instructions that are maintained on and executed by one or more servers 122 that are part of the platform's Application Server Tier 120.

Another business information system that may be provided as part of an integrated data processing and service platform is an integrated CRM system, which is designed to assist in obtaining a better understanding of customers, enhance service to existing customers, and assist in acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions. In addition to ERP and CRM functions, a business information system/platform (such as element 108 of FIG. 1) may also include one or more of an integrated partner and vendor management system, eCommerce system (e.g., a virtual storefront application or platform), product lifecycle management (PLM) system, Human Resources management system (which may include medical/dental insurance administration, payroll, and the like), or supply chain management (SCM) system. Such functions or business applications are typically implemented by one or more modules of software code/instructions that are maintained on and executed by one or more servers 122 that are part of the platform's Application Server Tier 120.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform.

The integrated business system shown in FIG. 1 may be hosted on a distributed computing system made up of at least one, but typically multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host” and the remote computers and the software applications running on the remote computers may be referred to as the “clients.” Depending on the computing service that a server offers it could be referred to as a database server, file server, mail server, print server, web server, and the like. A web server is a most often a combination of hardware and the software that helps deliver content (typically by hosting a website) to client web browsers that access the web server via the Internet.

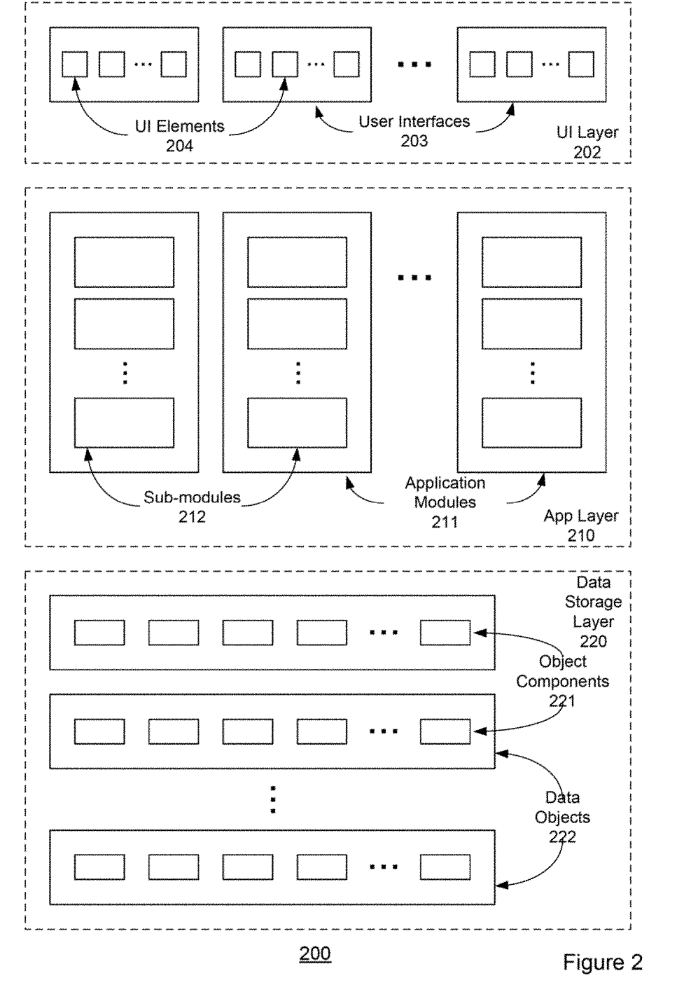

Rather than build and maintain such an integrated business system themselves, a business may utilize systems provided by a third party. Such a third party may implement an integrated business system as described above in the context of a multi-tenant platform, wherein individual instantiations of a single comprehensive integrated business system are provided to a variety of tenants. However, one challenge in such multi-tenant platforms is the ability for each tenant to tailor their instantiation of the integrated business system to their specific business needs. In one embodiment, this limitation may be addressed by abstracting the modifications away from the codebase and instead supporting such increased functionality through custom transactions as part of the application itself. Prior to discussing additional aspects of custom transactions, additional aspects of the various computing systems and platforms are discussed next with respect to FIG. 2.

FIG. 2 is a diagram illustrating additional details of the elements or components of the distributed computing service platform of FIG. 1, in which an embodiment may be implemented. The software architecture depicted in FIG. 2 represents an example of a complex software system to which an embodiment may be applied. In general, an embodiment may be applied to any set of software instructions embodied in one or more non-transitory, computer-readable media that are designed to be executed by a suitably programmed processing element (such as a CPU, microprocessor, processor, controller, computing device, and the like). In a complex system such instructions are typically arranged into “modules” with each such module performing a specific task, process, function, or operation. The entire set of modules may be controlled or coordinated in their operation by an operating system (OS) or other form of organizational platform.

In FIG. 2, various elements or components 200 of the multi-tenant distributed computing service platform of FIG. 1 are shown, in which an embodiment may be implemented. The example architecture includes a user interface layer or tier 202 having one or more user interfaces 203. Examples of such user interfaces include graphical user interfaces and application programming interfaces (APIs). Each user interface may include one or more interface elements 204. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 210 may include one or more application modules 211, each having one or more sub-modules 212. Each application module 211 or sub-module 312 may correspond to a particular function, method, process, or operation that is implemented by the module or sub-module (e.g., a function or process related to providing ERP, CRM, eCommerce or other functionality to a user of the platform). Such function, method, process, or operation may also include those used to implement one or more aspects of the inventive system and methods, such as for:
permitting a user to assign or change attributes of a job request type such as setting a specific priority to a specific task;
assigning processing resources to tasks based on the priority, the dependency of the task on others, and the dependency of other tasks on the task; and
if desired, permit the user to define a custom job type with specific resource allocation conditions.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 122 of FIG. 2) may include each application module. Alternatively, different application servers may include different sets of application modules. Such sets may be disjoint or overlapping.

The data storage layer 220 may include one or more data objects 222 each having one or more data object components 221, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

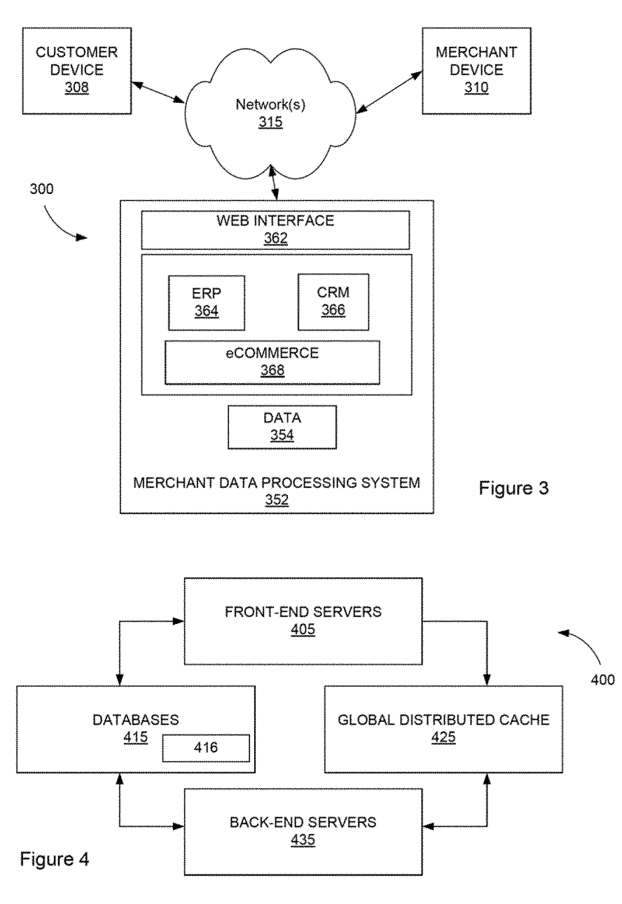

FIG. 3 is a diagram illustrating another perspective of a computing or data processing environment 300 in which an embodiment may be implemented. FIG. 3 illustrates a merchant's data processing system 352, where such a platform or system may be provided to and operated for the merchant by the administrator of a multi-tenant business data processing platform. Thus, the merchant may be a tenant of such a multi-tenant platform, with the elements that are part of system 352 being representative of the elements in the data processing systems available to other tenants. The merchant's data is stored in a data store 354, thereby permitting customers and employees to have access to business data and information via a suitable communication network or networks 315 (e.g., the Internet). Data store 354 may be a secure partition of a larger data store that is shared by other tenants of the overall platform.

A user of the merchant's system 352 may access data, information, and applications (i.e., business related functionality) using a suitable device or apparatus, examples of which include a customer computing device 308 and/or the Merchant's computing device 310. In one embodiment, each such device 308 and 310 may include a client application such as a browser that enables a user of the device to generate requests for information or services that are provided by system 352. System 352 may include a web interface 362 that receives requests from users and enables a user to interact with one or more types of data and applications (such as ERP 364, CRM 366, eCommerce 368, or other applications that provide services and functionality to customers or business employees).

Note that the example computing environments depicted in FIGS. 1-3 are not intended to be limiting examples. Alternatively, or in addition, computing environments in which embodiments may be implemented include any suitable system that permits users to access, process, and utilize data stored in a data storage element (e.g., a database) that can be accessed remotely over a network. Although further examples below may reference the example computing environment depicted in FIGS. 1-3, it will be apparent to one of skill in the art that the examples may be adapted for alternate computing devices, systems, and environments.

As briefly discussed above, a more robust an efficient manner for handling multiple job requests from multiple tenants in a multi-tenant platform is presented. To this end, an overview of various component blocks is shown in FIG. 4 in an example embodiment of a multi-tenant platform 400. In FIG. 4, each “component block” may be one or more computing entities, such as one or more server computers. In other embodiments, each block may be a processing entity such as a logical or virtual delineation of a larger computing platform, such as a computing module or operating environment.

The first block depicted is a front-end server block 405. The front-end server 405 is responsible for receiving job requests from tenants in the multi-tenant platform. Once received, the front-end server 405 may analyze the job request and then designate the job request as being served by the front-end server (for less-intensive tasks) or to delegate the job request to be served by back-end servers 435 (for resource-intensive tasks). If the front-end server simply handles the job request (because the received job request is simple enough to not require intensive use of computing resources), then the front-end server simply establish a thread to handle the job request. That is, when the job-request is simple enough, computing resources (CPU processing cycles, CPU time) of the front-end server are used to handle the job request. Thus, the front-end server 405 may utilize a database block 415 and a global distributed cache block 425 to store long-term and short-term data and instructions to handle the simple job request.

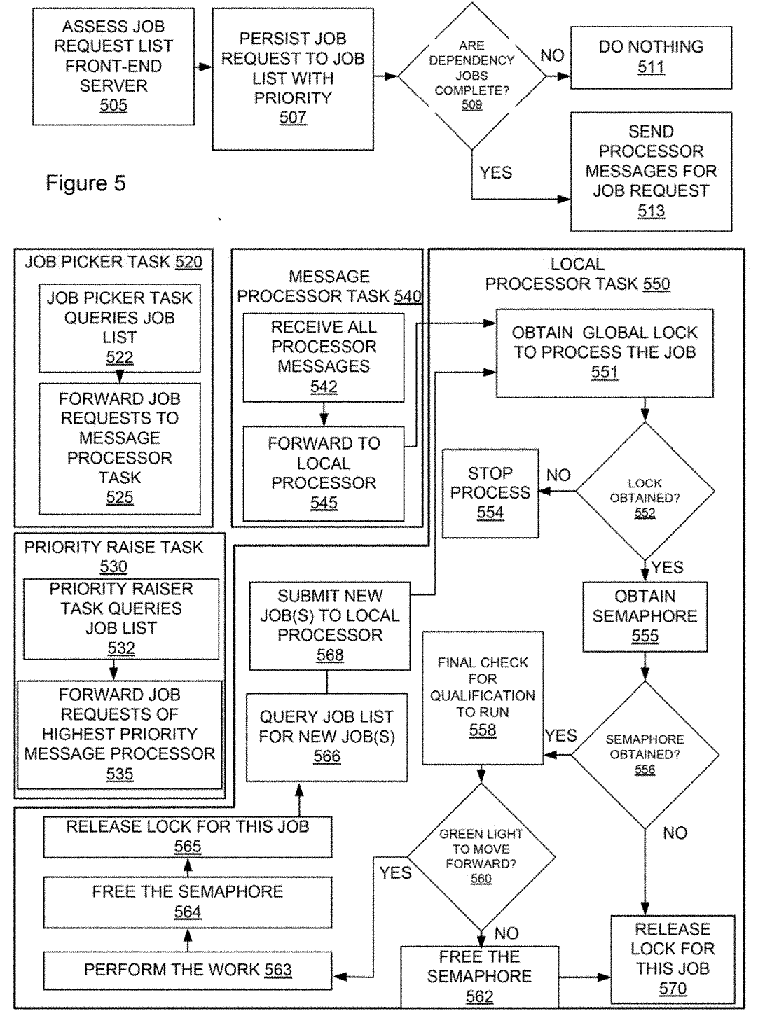

If, however, the job request is designated as requiring more intensive use of computing resources, then the job request is delegated to the back-end server block 435 in a manner described in the flow chart of FIG. 5. When a job request is delegated, the frontend server 405 stores job request definitions including job request data (the data that the job request will process) into a database block 415. In one embodiment, the frontend server 405 also stores job request definitions including job request data into a global distributed cache 425. Then, when the back-end server 435 takes up the task of handling the delegated job request, the back-end server 435 may also utilize the database block 415 and the global distributed cache 425 to store long-term and short-term data and instructions to handle the resource-intensive job request. Once handled, results may be stored in the database 415 block such that the front-end server 405 may return the result of the job request to the requesting tenant by retrieving the result from the database 415.

FIG. 5 is a flow chart or flow diagram illustrating a process, method, operation, or function for scheduling the processing of a set of job requests using a set of data processing elements, and that may be used when implementing an embodiment of the subject matter disclosed herein. Prior to discussing the flow chart depicting the handling of job requests, the nature of a job request is first discussed.

In one embodiment, each job request may include the following attributes that contribute to how the job request is to be handled at the front-end server 405. These attributes include type, priority, priority time, dependency list, and fail on dependency failure flag. The type attribute may sometimes be called the concurrency count and this attribute indicates how many jobs of a particular type for a particular tenant are allowed run in parallel at a time. Thus, this attribute is associated with the tenant and the overall number of job requests currently being requested. The priority attribute indicates a relative priority level for the job request. In one embodiment, the lower the number in the attribute, the higher the priority. The priority time attribute indicates the time when the job request was assigned the current priority. Tracking the priority time attribute allows a job picker task (described below) to raise the priority attribute of the job request later, if needed. The dependency list attribute tracks a list of other job requests in which the job request depends. As a general rule, a job request is not started before all the job requests in the dependency list are complete. Lastly, with respect to this list of attributes, a fail on dependency failure flag attribute determines what happens if one or more of the jobs in the dependency list fails. In one embodiment, if the flag is set to true, the job request is then also set to fail. If the flag is set to false, then dependency on failed jobs is ignored. These attributes are generally used to determine how a request fulfillment service may respond to a number of job requests received at a server.

With respect to FIG. 5, a server may receive several job requests simultaneously from various tenants of the multi-tenant platform. Each tenant may have a different set of rules governing the handling of job requests, but for the purposes of the descriptions of FIG. 5, all tenants are assumed to have identical governing rules without customization. As such, a front-end server receives and assesses the received job requests at step 505. At step 507, the priority attribute of each job request is assessed and the job request is persisted in a job list stored in the database 415 (FIG. 4). As new job requests are received, the list of job requests may be updated such that newer jobs with a higher priority may be placed on the job list at a higher point than older jobs with a lower priority. Once a job request begins processing (e.g., passes to step 563, as discussed below) at a back-end server 435, it is marked as processed in the job list. In this context, the term “processing” describes a thread that is used to process jobs. A processing thread can process at most one job at a time.

After a job request is stored in the job list, the front-end server 405 may then initiate the sending of processor messages that may trigger assigning job requests to back-end servers for additional handling. So as to not generate a processor message for a job request still awaiting job dependencies to be fulfilled, the front-end server checks each job just established in the job list for the dependency list attribute at step 509. If the attribute indicates that a job request is still awaiting fulfillment of a separate job request (e.g., this job “A” is dependent upon fulfillment of another job “B”), the method moves to step 511 with regard to the job request still awaiting dependent job fulfillment. That is, do nothing at step 511.

If, at step 509, the particular job request being assessed for job dependencies indicates that all dependencies of a particular job request are fulfilled, the front-end server generates, at step 513, a processor messages to send to the message processor task 540 to process the job request at step 513.

In conventional systems, one straightforward way to process job requests assigned to back-end servers is to query a job list storing such assigned job requests periodically to identify a certain number of yet unprocessed job requests in the order in which they were stored in the database. Such a straight forward processing ensures first-in-first-out (FIFO) order, and so prevent starvation. Typically, a locking mechanism may ensure that two back-end servers are not processing the same job. The lock is implemented using a lock procedure in conjunction with the global distributed cache 425 (FIG. 4). Each server can process only a limited number of jobs in parallel. This can be a fixed number or a number based on the current load. The jobs that do not fit into the limit must wait for another run of the periodic task that assigns job requests from the job list. There is typically also a per-user (or per customer—potentially having a number of users) limit.

In such conventional systems, there is a limit on the number of job requests of one customer that can be processed in parallel. The limit is typically determined based on the customer's subscription. Further, conventional systems do not take priorities into account and also cannot handle job dependencies. By analyzing the attributes of all received job requests that are to be assigned to back-end processing, the system and underlying method depicted in FIG. 5 processes all job requests more efficiently than conventional systems.

As the front-end server 405 identifies resource-intensive job requests, the delegation to back-end servers 435 may be handled using a number of simultaneously executing and cooperating tasks in one embodiment. Firstly, the frontend server(s) stores job request definitions including job data (the data that the job is supposed to process) in a job list in a database 415 (as shown in FIG. 4). Secondly, the front-end server 405 sends processor messages (i.e., one processor message per job request being assigned to back-end servers) to process the job requests using four back-end server processing routines. These four routines, modules, or sub-systems run on backend servers and are hereinafter referred to as tasks. These four tasks include a job picker task 520, a priority raiser task 530, a message processor task 540 and a local processor task 550. Each of these tasks may be run periodically and with differing periods that may be customized according to a user's desired performance parameters.

When a job request is sent to a back-end server for processing, a processor message corresponding to the job request may be received by the message processor task 540 at receive step 542, which then may delegate, at step 545, the actual job request processing to a local processor task 550. The processor messages are received by the message processor task 540. One or more message processor tasks 540 may be executed on each backend server 435 periodically. The period can be, for example, ten seconds, such that every ten seconds, the message processor task 540 selects one or more (often several) job requests to send to an available processor task 550 at the back-end servers 435. The periodic execution of the message processor task 540 can be accomplished by a timer function of high-level programming languages. The periods across various back-end servers 435 for the respective message processor tasks 540 may be staggered or simultaneous according to programming preference.

The local processor task 550 is a new thread spawned by the message processor task 540. The purpose of a local processor task 550 is the processing of a single job request and this may be assured through a locking handshake procedure. Thus, when a local processor task 550 is assigned to process a job request, the local processor task 550 attempts to obtain a lock at step 551 in order to ensure that no other local processor task has already taken the job request. The method then determines whether or not the lock has been obtained at step 552. If not lock has been obtained, the local processor task 550 stops processing this job request at step 554 and may be reset to an initial state ready to accept new job requests or the local processor thread may be terminated.

If, however, the lock is obtained, the method then seeks to determine if the overall tenant-assigned resources may handle a new job request of this type. Generally, each user may have limitations placed on how many simultaneous job requests may be executing having the same or similar type, a so-called concurrency limit as indicated in the job type attribute of a job request. Therefore, the system may use a semaphore access-control scheme to enforce limitations on concurrent processing of job requests for a tenant. At step 555, a semaphore for the particular job type corresponding to the job request is determined. That is, with tenants who may have limitations placed on the number of concurrent job requests of the same type that may be processed, the system may not allow the processing of another concurrent job request until other previously begun jobs are completed. For example, if a limit of five concurrent job requests of type A are allowed, only five semaphores at a time may be respectively assigned to the job requests of type A. If all five semaphores are locked, then the sixth job request of type A must wait for one of the initial five job requests of type A to be finished so as to release one of the five allotted semaphores. If no semaphore is obtained at step 556, the processing of this job request is terminated and the lock is released at step 570. This frees up the local processor task 550 to begin processing a new job request.

If a semaphore is obtained, the local processor task 550 may query the job list again to determine if any other job request waiting has a higher priority than the job request about to be processed. Additionally, besides checking for priority, the job request that is now locked and has acquired an assigned semaphore is checked again to ensure that job request dependencies are fulfilled. For example, if the current job (A), still depend on an unfinished job (B), then the method does not grant permission (e.g., the job is at a red light) to proceed to processing. This step serves as a final check against the job list to ensure that higher priority jobs that may still be in the job list are to be processed before lower priority jobs and to ensure that any jobs that have dependencies still waiting are not going to be processed. In this sense, if no other job request in the job list has a higher priority and all job dependencies are fulfilled, then the local processor task 550 has the “green light” to move forward with processing at step 560. If this final check at step 558 reveals that at least one job request remains in the job list that has a higher priority or has unfinished job that this job depends on, then processing of the job request that has the lock and is already assigned a semaphore is terminated by releasing the semaphore at step 562 and releasing the lock at step 570.

If there is no higher-priority job request in the job list, the local processor task 550 may then proceed to process the job request at step 563. After performing the work and completing the processing of the underlying job of the job request, the method may then release the semaphore at step 564 just before releasing the lock at step 565. At step 566, the local processor task 550 may query the job list in the database for similar jobs again to possibly obtain one or more new job requests from the job list in the database. In one embodiment, the job requests may be similar such that semaphores available for concurrent jobs by one tenant are fulfilled. Thus, at step 568, one or more new threads are immediately established with one or more local processor tasks 550. This is to increase the throughput of the overall system. Thus, when a local processor task 550 finishes, the local processor task 550 may look into a job list in the database for new pending jobs and then spawn new local processors to process those jobs. Step 566 assists with efficiently assigning a new job request to an available local processor task 550 just as the local processor task 550 finishes with a previous job request. Such a step may allow a local processor task 550 to be assigned a new job request faster than relying on other tasks (such as the message processor task 540 and the job picker task 520).

In case a job is not processed (i.e., not as a result of sending a processor message from the frontend, or as a result of a local processor's query for new jobs), the system may use a different mechanism to pick up a job in some other way. In one embodiment, this is the purpose of the job picker task 520 described next. If no further job requests are pending, the local processor task 550 may lie dormant until assigned new job requests from the message processor 540.

The job picker task 520 may also be run periodically for each database. The period can be, for example, five minutes. The periodic execution of the job picker task 520 can be accomplished by selecting one back-end server to be a “periodic database task initiator” with the purpose of this back-end server being to send one message for each database every 5 minutes. Other back-end servers receive these messages and start the job picker tasks. In this way, the job picker task 520 may be considered a specific kind of job. The periodic sending of database task initiator messages may be accomplished by a timer functionality available to the computer system. One purpose of the job picker task 520 is to query a target job list in a database at step 522 and to pick pending jobs from the target job list to send a processor message at step 525 to be received by the message processor task 540. Thus, the job picker task 520 assists with ensuring that job requests in a database having all dependencies fulfilled are placed in queue at the message processor task 540.

In order to further ensure that job requests in a database are not starved, a priority raiser task 530 is also executed periodically for each database. The period can be, for example, 15 minutes. The periodic execution of the priority raiser task 530 can again be accomplished by the periodic database task initiator. The purpose of the priority raiser task 530 is to raise the priority of jobs that are sitting in lower-priority queues of a job list for at least a requisite amount of time. For example, a requisite wait of 10 minutes may be sufficient to avoid starvation. Thus, every 15 minutes, any job requests having a lower priority attribute may be identified in the job list at step 532 as exceeding the requisite waiting time. Further, prior to raising the priority of identified job requests, an additional check may be accomplished by checking to see of a queue in which a job request priority is to be raised to has a latest job request waiting that was, itself, placed there because of priority raising, then the new job request identified is held in the same queue. This is to prevent raising too many job requests to a higher priority queue. After raising appropriate job request priorities, the priority raiser task may then forward one or more “next-in-line” processor messages to the message processor task 540 at step 535.

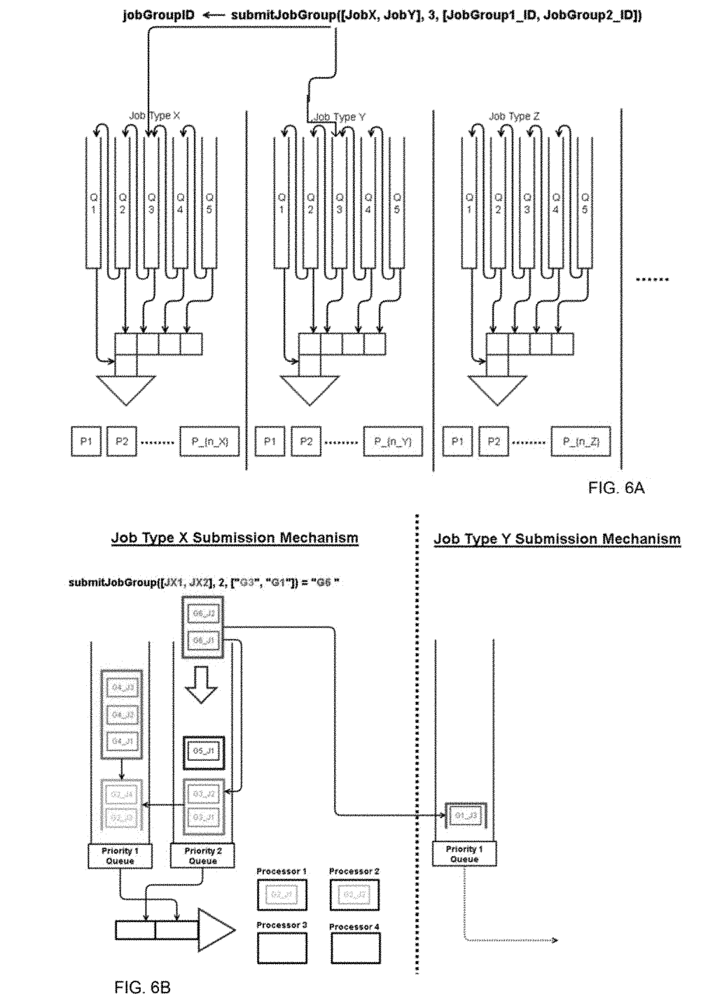

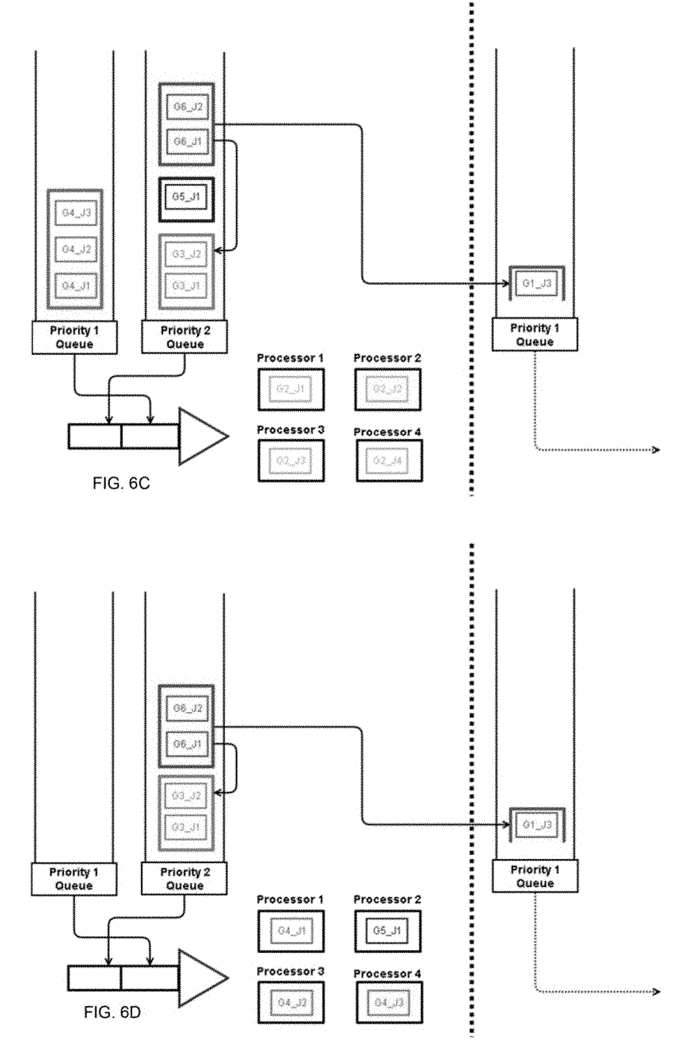

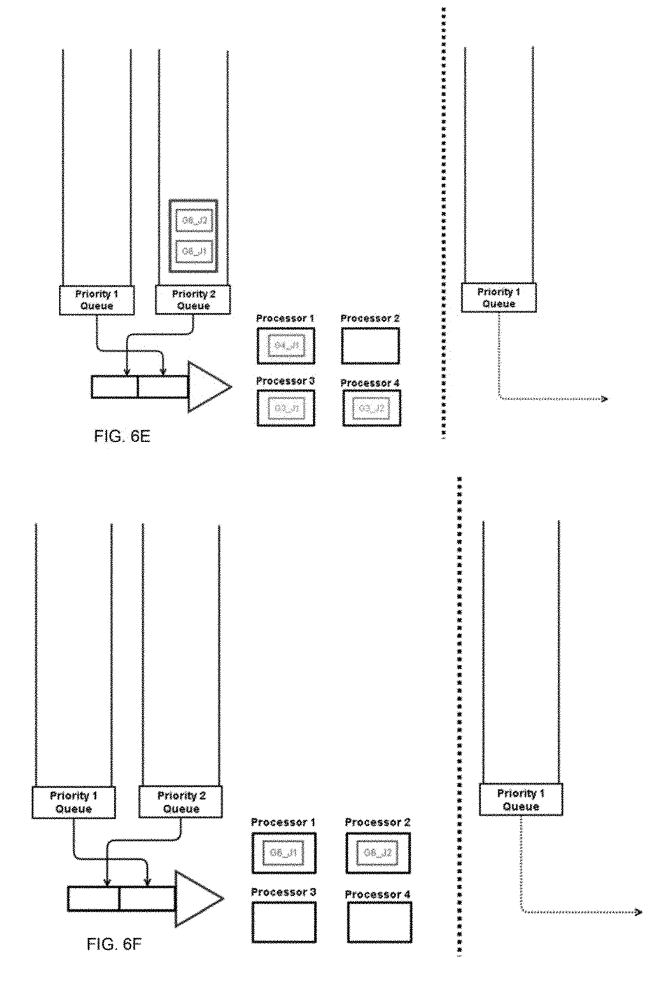

The tasks of the back-end servers 435 as described above are better understood with respect to the example job flow illustrated in FIGS. 6A-6F.

FIGS. 6A-6F illustrate an example embodiment of a job work flow as influenced by user customization for asynchronous processing in an exemplary multi-tenant platform suited to execute aspects of the systems and methods described herein. FIG. 6A is a generalized depiction of a number of queues for each delineated job type. In this embodiment, a set of job queues for job type X, job type Y and job type Z are shown. Each grouping of queues by job type is further delineated by priority with Q1 being the highest relative priority down to Q5 being the lowest relative priority.

In one embodiment, the number of priority queues for each job type is fixed. Jobs to execute (e.g., assign a processor task) are chosen from queue Qi only if each queue Qj, such that j<i, is empty. This is depicted by the segmented arrows pointing down to processor blocks. The arrows going from lower priority queues to higher priority queues illustrate that after a certain period of time a job is taken from queue (i+1) and placed at the end of queue i to avoid starvation (as discussed above with respect to the priority raiser task 530). The picture does not illustrate dependency of jobs. The rule for dependency is simple. If a job has unfinished jobs it depends on, it is not considered for execution and the next job in order is taken, and so on.

When a job request is submitted, several jobs may be part of the same job request. In FIG. 6A, a first job of type X and second job of type Y are submitted at the same time. Both jobs have priority 3 so these jobs are assigned to Q3 of job type X and Q3 of job type Y, respectively. In this example, these jobs may depend on job groups specified by the identification “JobGroup1_ID” and “JobGroup2_ID”. The dependency is not depicted in FIG. 6A.

Moving to FIGS. 6B-6F, this series of illustrations show further aspects of the handling of jobs. FIG. 6B shows a state of the system as well as submission of a new job group. This depiction focuses on the job type X. Job type X may have four processors (four processor tasks 550) at its disposal which are depicted in the lower right corner. For simplicity, there are only two priorities, which correspond to two virtual queues. Priority 1 is the highest priority queue as indicated by the segmented arrow that “transfers” jobs to the processors. Further for simplicity, job groups consist only of jobs of the same type.

There are five job groups with jobs of type X in example of FIG. 6B, G2 through G6. The number of a job group indicates the time of its submission; the lower the number, the sooner it was submitted. The first submitted job group of type X is G2. It consists of four jobs: G2_J1 through G2_J4, has priority 1, and does not depend on any other job group. Two of the four jobs are currently being processed on processors 1 and 2. Job group G3 consists of two jobs. It has priority 2 and depends on job group G2, which means that none of jobs in job group G3 can start before all jobs in G2 finish. Job group G4 consists of three jobs, has priority 1, and depends on job group G2. Job group G5 consists of only one job, has priority 2, and does not depend on any other job group. Finally, job group G6 consists of two jobs and is just being submitted.

At the time of submission of job group G6, the identification “G6” is not known yet; it will be determined during the submission procedure and returned from a submit group job method. Therefore, jobs of job group G6 are referred to as JX1 and JX2 in the submit method arguments. Job group G6 has priority 2, and populates the priority 2 queue. Job group G6 also depends on job group G3, and also on job group G1, which contains jobs of different job type. Job G1 is currently in priority 1 queue of job type Y and consists of three jobs, two of which have already been processed or are currently being processed. The remaining depictions shown in FIGS. 6C-6F illustrate how the system would progress in case no other jobs are submitted.

There are two free processors for job type X, processors 3 and 4. These will be occupied by job J3 and J4 of job group G2. This is depicted in FIG. 6C. Then, after at least one of the jobs of G2 finishes, job J1 of job group G5 starts, because all the other jobs depend directly or indirectly on job group G2, and it is very unlikely that all jobs of G2 complete at the same time. Thus, jobs depending on G2 would not overtake job G5_J1. Assuming the first finished job of G2 is job J2, the next resultant state is depicted in FIG. 6D.

Turning to FIG. 6E, after job group G2 is complete, all jobs of G4 are assigned a processor. As soon as any one processor becomes free, jobs in group G3 are started. Assuming that jobs J2 and J3 of group G4 finished, job G5_J1 finished, and also job G1_J3 in the job Y queue. finished, the system now only has jobs of job group 6 in priority 2 queue as shown in FIG. 6E. Finally, after job group G3 is finished, jobs of job group G6 can be started, provided that job group G1 is also complete, which is true in this example. Further, once G4_J1 is complete, two of the four processors may take of the jobs of job group 6 as shown in FIG. 6F.

The example embodiments of FIGS. 6A-6F show how an asynchronous processor model selects jobs for processing without any customized rules for altering the selection order. That is, the above-described example may be a set of default rules for handling the processing of job requests. A user may choose to customize the manner in which these various tasks work together in an effort to handle specific job requests differently or to take best advantage of dedicated processor tasks available to the user. Thus, the following example customizations may be implemented by a user of the multi-tenant platform either in isolation of each other or in any possible combination.

In a first customization, a user may define the allocation of the total number of processor tasks that may be assigned to process a specific job type simultaneously, e.g., define the number of semaphores available. In one embodiment, this allocation may only be available to adjust for a simultaneous number of job sub-types. A Job sub-type may be similar to a non-customized job type which is assigned to dedicated processors. The purpose of the sub-types is to provide a user with better control over the processing resources. For example, a user may assign certain high-priority jobs of type X to its sub-type A. In this manner, the user assigns the use of A's dedicated processor only for those high-priority jobs. Users may not easily change the total number of processors across all job types as the total number of processors is typically set based on a subscription level. However, users may move processors between job types. So, for example, if the user discovers that the job type X, sub-type A needs extra processors, the user may assign a processor from, for example, job type Y, sub-type A.

The above customization may be further customized by allowing jobs of a sub-type to use processors of its base type under some conditions (e.g., all processors of the sub-type are occupied). The user may also choose to allow the opposite—allow the jobs of a parent type to use processors of its sub-types under some conditions.

In another customization, a user may create job request of a particular type, but the default priority may be changed based upon the user that initiated the job request. That is, a user may assign different priority based on the different users who initiate the same job request type. For example, a job request of a known type may be altered as having a priority of one if the job request corresponds to a particular user of the multi-tenant platform whereas other job types that may be similar have a priority of two when originated by any other user. As another example, a specific type of job request may be defined having a specific priority attribute and other custom attributes in order to be handled in a specific manner desired by the user.

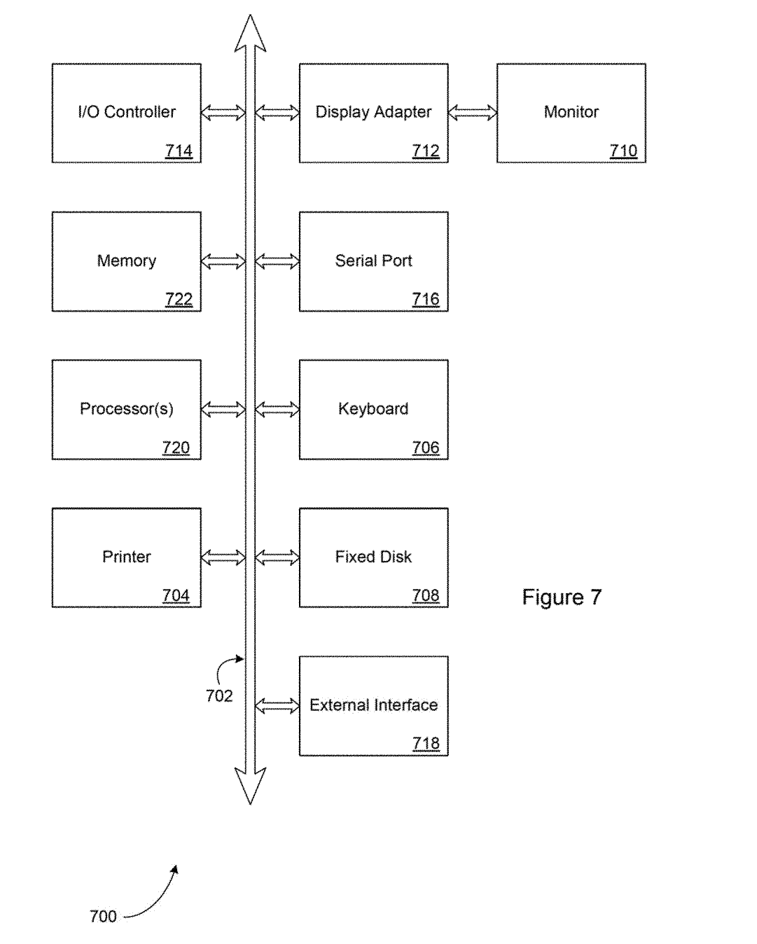

In accordance with one embodiment, the system, apparatus, methods, processes, functions, and/or operations for enabling efficient configuration and presentation of a user interface to a user based on the user's previous behavior may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 7 is a diagram illustrating elements or components that may be present in a computer device or system 700 configured to implement a method, process, function, or operation in accordance with an embodiment. The subsystems shown in FIG. 7 are interconnected via a system bus 702. Additional subsystems include a printer 704, a keyboard 706, a fixed disk 708, and a monitor 710, which is coupled to a display adapter 712. Peripherals and input/output (I/O) devices, which couple to an I/O controller 714, can be connected to the computer system by any number of means known in the art, such as a serial port 716. For example, the serial port 716 or an external interface 718 can be utilized to connect the computer device 700 to further devices and/or systems not shown in FIG. 7 including a wide area network such as the Internet, a mouse input device, and/or a scanner. The interconnection via the system bus 702 allows one or more processors 720 to communicate with each subsystem and to control the execution of instructions that may be stored in a system memory 722 and/or the fixed disk 708, as well as the exchange of information between subsystems. The system memory 722 and/or the fixed disk 708 may embody a tangible computer-readable medium.

It should be understood that the present disclosures as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

1. A computer-implemented method, comprising:
receiving a job request to process a task from a user of multi-user platform, the job request received by a front-end server;
identifying one or more attributes of the job request at the front-end server;
persisting the job request to one and only one prioritized database of jobs ordered according to the one or more attributes, the job persisted to the prioritized database of jobs in the order according to the one or more attributes of the job request being persisted;
allocating one or more resources of a back-end server to process the job request in response to the one or more attributes of the job request; and
in response to completing processing of the job request, adjusting the prioritized database of jobs.

2. The computer-implemented method of claim 1, wherein identifying an attribute further comprises identifying a job request type indicative of a type of job request that differentiates the job request from other job request types.

3. The computer-implemented method of claim 1, wherein identifying an attribute further comprises identifying a job request priority indicative of an order in which a job request is to be processed that differentiates the job request priority from other job request priorities.

4. The computer-implemented method of claim 3, wherein identifying an attribute further comprises identifying a job request priority time indicative of an order in which a job request is to be processed that differentiates the job request priority time from other job request having the same job request priority time.

5. The computer-implemented method of claim 1, wherein identifying an attribute further comprises identifying a job request dependency indicative of one or more other job requests be processed prior to processing the job request.

6. The computer-implemented method of claim 1, wherein identifying an attribute further comprises:
identifying a job request dependency fail flag; and
if the job request dependency fail flag is set and a dependent job request is incomplete, dismissing the job request.

7. The computer-implemented method of claim 1, further comprising periodically raising the priority of a job request in a queue of job requests.

8. The computer-implemented method of claim 1, wherein allocating the resource comprises allocating a job request processor task to process the job request from an available pool of processor tasks.

9. The computer-implemented method of claim 1, wherein allocating the resource further comprises:
determining a number of processor tasks currently processing other job requests having a similarity to the job request; and
if the number of processor tasks is at or less than a maximum allowed number of simultaneously processing tasks, allocating a job request processor task to process the job request from an available pool of processor tasks.

10. The computer-implemented method of claim 1, further comprising:
creating a customized job type having one or more attributes corresponding to a customized job request; and
allocating one or more resources of the back-end server to process the customized job request in response to the one or more attributes of the customized job request.

11. A multi-user computing platform, comprising:
at least one front-end server configured to receive one or more job requests from one or more users of the multi-user computing platform;
one and only one database configured to store job requests, the job requests stored in an order with job request attributes indicative of job request handling procedure, the database further configured to update the stored job requests in response to completion of each job request; and
at least one back-end server configured to select a job request for processing based on the one or more stored job request attributes.

12. The multi-user platform of claim 11, wherein the job request attribute further comprises a job request type indicative of a type of job request that differentiates the job request from other job request types.

13. The multi-user platform of claim 11, wherein the job request attribute further comprises a job request priority indicative of an order in which a job request is to be processed that differentiates the job request priority from other job request priorities.

14. The multi-user platform of claim 13, wherein the job request attribute further comprises a job request priority time indicative of an order in which a job request is to be processed that differentiates the job request priority time from other job request having the same job request priority time.

15. The multi-user platform of claim 11, wherein the job request attribute further comprises a job request dependency indicative of one or more other job requests be processed prior to processing the job request.

16. The multi-user platform of claim 11, wherein the job request attribute further comprises a job request dependency fail flag such that if the job request dependency fail flag is set and a dependent job request is incomplete, the job request is dismissed.

17. The multi-user platform of claim 11, wherein the one or more back-end servers further comprise a job picker task configured to select job requests from the database to populate a message processor task according to the attributes of job request stored in the database.

18. The multi-user platform of claim 11, wherein the one or more back-end servers further comprise a priority raiser task configured to alter a priority attribute of one or more job requests stored in the database.

19. A non-transitory computer-readable medium having computer-executable instructions for improving the performance of a multi-tenant computing platform, the instructions configured to cause a computer to:
receive a job request to process a task from a user of the multi-user platform, the job request received by a front-end server;
identify one or more attributes of the job request at the front-end server;
persist the job request to one and only one prioritized database of jobs ordered according to the one or more attributes, the job persisted to the prioritized database of jobs in the order according to the one or more attributes of the job request being persisted;
allocate one or more resources of a back-end server to process the job request in response to the one or more attributes of the job request; and
in response to completion of processing of the job request, adjust the prioritized database of jobs.

20. The non-transitory computer-readable medium of claim 19 having further computer-executable instructions to cause a computer to process a task of the job request based on one or more of the group of attributes including: a job type, a job priority, a job priority time, and a job dependency.
